(19) United States
(12) Patent Application Publication
(10) Pub. No.: US 2026/0247512 A1
(43) Pub. Date: Aug. 20, 2026

(54) LOAD FLICKERING CORRECTION FOR LUMINAIRE

(71) Applicant: SIGNIFY HOLDING B.V., EINDHOVEN (NL)

(72) Inventors: ATUL KAUSHIK, GURUGRAM (IN); MANOJ KUMAR, MEERUT (IN); SHUAIB AHMED, DELHI (IN); SUMIT DALAL, GHAZIABAD (IN); MUKESH KUMAR, NOIDA (IN)

(21) Appl. No.: 19/162,498

(22) PCT Filed: Mar. 5, 2024
(86) PCT No.: PCT/EP2024/055743

§ 371 Date: Sep. 5, 2025

(30) Foreign Application Priority Data
Mar. 8, 2023 (IN) 202341015477
Jun. 13, 2023 (EP) 23178945.4

(51) Int. Cl. H05B 45/59; F21S 9/03; H02J 7/35; H02J 7/82; H02J 7/90

(52) U.S. Cl. CPC H05B 45/59; F21S 9/03; H02J 7/35; H02J 7/82; H02J 7/971

(57) ABSTRACT

A method of operating a luminaire, the luminaire comprising or being coupled to a battery, the battery being coupled via a grid charging unit to a mains grid, and the luminaire comprising or being coupled to a solar unit; the method comprising: detecting whether or not a condition indicating lighting conditions in an environment of the luminaire is below a predetermined threshold; determining whether or not the battery is being charged; if the condition indicating lighting conditions being below the predetermined threshold is detected and if it is determined that the battery is being charged, detecting load flickering of the luminaire, wherein the load flickering is attributable to a load ripple through the battery, wherein the load ripple is due to the coupling of the battery with the grid charging unit; and if load flickering of the luminaire is detected, correcting the load flickering of the luminaire.

### TECHNICAL FIELD

The present disclosure generally relates to load flickering in luminaires. Particular embodiments relate to operating a luminaire, in order to correct such load flickering.

### BACKGROUND

Some modern luminaires contain or are coupled with a battery and a solar unit (comprising one or more solar panels and a solar charge controller coupling the solar panels with the battery). Power from the solar unit may be used to charge the battery during day time and may be drawn from the battery during night time, i.e. after dusk, to output light from a light unit of the luminaire, such as an LED (Light Emitting Diode) or an LED array.

Sometimes, an operator may add a grid charging unit for charging the battery during night time, in order to avoid a blackout wherein the luminaire would not output light during the night time. Such a grid charging unit is typically installed afterwards as an external element, and is typically coupled directly to the battery.

Such a grid charging unit is however not suitable for optimal charging of the battery, but luminaires are usually compatible with grid charging unit and allow their use, as this is considered more customer-friendly for the operators.

However, coupling such a grid charging unit with the battery amounts to coupling the mains grid with the battery, which may create ripples in the battery charging voltage and thus in the load output and in the light output, which may be unpleasant for users of the luminaires.

US2018238563 A1 is related to efficient use of solar photovoltaic energy. The problem addressed by this document is to mitigate the problems associated with AC and DC power supply provided to the water heating unit using photovoltaic energy. US2018238563 A1 provides a technique to prioritize delivery of energy from variable energy source to internal consumption systems before utility grid feed-in.

WO2018007182 A1 is related to lighting and power control system with increased dynamic response for improved light quality. WO2018007182 A1 is aimed at reducing the ripple component by using a notch filter configured to filter out the ripple frequency in the regulated current output provided to the load.

### SUMMARY

Therefore, it is an aim of at least some embodiments of the present disclosure to address this problem.

Accordingly, there is provided in a first aspect of the present disclosure a method of operating a luminaire. The luminaire may comprise or may be coupled to a battery, and the battery may be coupled via a grid charging unit to a mains grid. The luminaire may comprise or may be coupled to a solar unit. The method may comprise:
detecting whether or not a condition indicating lighting conditions (e.g. any one or more of dusk, darkness, night time, etc.) in an environment of the luminaire is below a predetermined threshold;
determining whether or not the battery is being charged;
if the condition indicating lighting conditions being below the predetermined threshold is detected and if it is determined that the battery is being charged, detecting load flickering of the luminaire, wherein the load flickering is attributable to a load ripple through the battery, wherein the load ripple is due to the coupling of the battery with the grid charging unit; and
if load flickering of the luminaire is detected, correcting the load flickering of the luminaire.

It is noted that the solar unit may comprise one or more solar panels and a solar charge controller coupling the solar panels with the battery, but the skilled person will appreciate that this is not essential for understanding the above-described method embodiment, which only requires that the luminaire is coupled via a grid charging unit to a mains grid, and either comprises or is coupled to solar unit, and either comprises or is coupled to a battery. It is also to be understood that the luminaire may comprise a light unit configured to output light, and that examples of such a light unit may include an LED (Light Emitting Diode) or an LED array containing a plurality of LEDs. The grid charging unit may be considered as an element that is external to the luminaire, as it is typically coupled directly to the battery and is not a part of the luminaire itself. Of course, the logical decisions and operations performed by the luminaire may be performed by a controller. Such a controller may form part of the luminaire, and may for example comprise a computer processor and a memory, or may for example be a dedicated electronic hardware assembly. In another exemplary embodiment, such a controller may not be embodied within the luminaire, but may instead be a remote, e.g. cloud-based, computer processor with an associated memory.

The expression “a condition indicating lighting conditions” may be taken to refer to a parameter or an indication representing an external situation of an intensity of light in the surroundings/environment of the luminaire.

In an embodiment, the method may comprise, if load flickering of the luminaire is not detected, or if it is determined that the battery is not being charged, maintaining an output state (i.e. a light output setting of the light unit) of the luminaire.

It is to be understood that a luminaire generally has an output state, i.e. a light output setting, which represents whether or not the luminaire is emitting light (or more precisely, whether or not the light unit of the luminaire is emitting light). Furthermore, in more advanced models of the states of the luminaire, additional output states may be considered, e.g. an activation or deactivation state, i.e. a sort of warmup or cooldown state respectively, or any other relevant state. As is well-known, a luminaire (or more precisely, the light unit of a luminaire) may emit light by driving a load, such as a LED load. This implies that an output state of the luminaire is determined by whether or not the load is being driven (and, in more advanced models, how it is being driven). This in turn implies that an output state of the luminaire is influenced by electrical conditions to which the load is subjected, such as a load ripple, which is an variation in a voltage or current imposed on the load, which may lead to related perceptible or imperceptible (to the human eye or even to digital cameras having a particular shutter frequency) changes to the output state of the luminaire. The luminaire may in that case for example suffer from load flickering, which is a situation wherein the light output from the luminaire appears to vary by periodically increasing and decreasing in intensity (and optionally in colour). This effect on the output state of the luminaire is in general undesirable if it is too perceptible to human eyes, and/or to digital cameras having a particular shutter frequency. However, if this effect is imperceptible, the output state of the luminaire may be maintained, which means that the light output may be maintained even if there is a load ripple present over the load, because the load ripple may be deemed insignificant to end users of the luminaire.

In an embodiment, the method may comprise:
if the condition indicating lighting conditions being below the predetermined threshold is not detected and if it is determined that the battery is being charged, adapting a charging profile of the battery of the luminaire in order to increase power being extracted from the grid charging unit.

In an embodiment, the condition indicating lighting conditions being below the predetermined threshold is detected by detecting a lack of photovoltaic current reaching the battery from the solar unit.

In an embodiment, wherein the condition indicating lighting conditions being below the predetermined threshold is detected by consulting a predefined timetable and using a datetime clock.

In an embodiment, the step of determining whether or not the battery is being charged is performed by measuring a state of charge of the battery to determine whether or not the battery voltage is increasing.

In an embodiment, the step of detecting load flickering of the luminaire comprises detecting a load current ripple deviating from a load current setting by more than 3.5 percent, preferably by more than 5 percent.

In an embodiment, the predetermined threshold represents a cut-off between day time with higher lighting conditions and night time with lower lighting conditions.

In an embodiment, the predetermined threshold varies depending on the date and/or the season.

Furthermore, there is provided in a second aspect of the present disclosure a computer program comprising instructions which, when the program is executed by a computer, cause the computer to carry out the method of any preceding claim.

Furthermore, there is provided in a third aspect of the present disclosure a computer-readable storage medium comprising instructions which, when executed by a computer, cause the computer to carry out the method according to any above-described embodiment.

Furthermore, there is provided in a fourth aspect of the present disclosure a computer apparatus comprising a processor and a memory, the memory storing instructions which, when executed by the processor, cause the computer apparatus to carry out the method according to any above-described embodiment.

Furthermore, there is provided in a fifth aspect of the present disclosure a luminaire comprising or being coupled to a battery, the battery being coupled via a grid charging unit to a mains grid, and the luminaire comprising or being coupled to a solar unit; wherein the luminaire comprises a controller configured to cause the luminaire to carry out the method according to any above-described embodiment.

The skilled person will understand that various considerations and advantages applying for various embodiments of the method may apply analogously for various embodiments of the computer program, the computer-readable storage medium, the computer apparatus and the luminaire, mutatis mutandis. In particular, any step or steps of a method embodiment described herein, may correspond with logic and/or hardware in any of the cited elements.

Additionally, there is provided in another aspect of the present disclosure a method of operating a luminaire. The luminaire may comprise or may be coupled to a battery, and the battery may be coupled via a grid charging unit to a mains grid. The luminaire may comprise or may be coupled to a solar unit. The method may comprise:
detecting whether or not a condition indicating lighting conditions (e.g. any one or more of dusk, darkness, night time, etc.) in an environment of the luminaire is below a predetermined threshold;
determining whether or not the battery is being charged;
if the condition indicating lighting conditions being below the predetermined threshold is detected and if it is determined that the battery is being charged, detecting load flickering of the luminaire, wherein the load flickering is attributable to a load ripple through the battery, wherein the load ripple is due to the coupling of the battery with the grid charging unit; and
if load flickering of the luminaire is not detected, or if it is determined that the battery is not being charged, maintaining an output state (i.e. a light output setting) of the luminaire.

Additionally, there is provided in another aspect of the present disclosure a method of operating a luminaire. The luminaire may comprise or may be coupled to a battery, and the battery may be coupled via a grid charging unit to a mains grid. The luminaire may comprise or may be coupled to a solar unit. The method may comprise: detecting whether or not a condition indicating lighting conditions (e.g. any 25-one or more of dusk, darkness, night time, etc.) in an environment of the luminaire is below a predetermined threshold;
determining whether or not the battery is being charged;
if the condition indicating lighting conditions being below the predetermined threshold is not detected and if it is determined that the battery is being charged, adapting a charging profile of the battery of the luminaire in order to increase power being extracted from the grid charging unit.

It is to be understood that any of the considerations and advantages applying to the above-described more detailed embodiments of the method of the first aspect of the present disclosure may analogously be applied to further developed embodiments of the additionally provided method of the other aspects recited directly above.

Moreover, it is to be understood that in particular embodiments of any of the above-described methods, the method may be computer-implemented.

### BRIEF DESCRIPTION OF THE DRAWINGS

The present disclosure and the above-described embodiments may be more fully understood with the help of the following detailed description of the appended drawings, in which:

FIG. 1 shows a flowchart schematically illustrating an embodiment of a method according to the present disclosure; and

FIG. 2 schematically illustrates an embodiment of a luminaire 100 according to the present disclosure.

### DETAILED DESCRIPTION

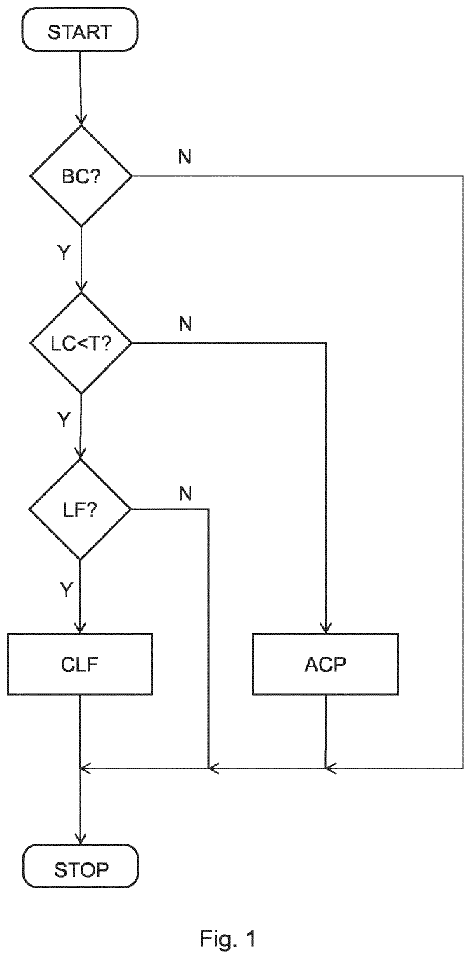

FIG. 1 shows a flowchart schematically illustrating an embodiment of a method 10 according to the present disclosure. The method is a method of operating a luminaire. The luminaire comprises or is coupled to a battery, the battery being coupled via a grid charging unit to a mains grid. The luminaire comprises or is coupled to a solar unit. Reference is made here to the additional considerations described above with regard to the details of the solar unit, the implicit presence of a light unit, and the optional presence of a controller, if any or all of these are necessarily or advantageously included in various embodiments.

The method embodiment comprises the following steps.

In a first step, labelled “BC?”, it may be determined whether or not the battery is being charged. Note that the label “BC?” may be taken to refer to the English language expression “battery charging?” as a convenient shorthand.

If it is not determined that the battery is charging, or, equivalently, if it is determined that the battery is not charging, then no specific further action needs to be taken and the method embodiment may halt.

If, however, it is determined that the battery is charging, then operation of the method embodiment may proceed.

In a second step, labelled “LC<T?”, it is detected whether or not a condition indicating lighting conditions in an environment of the luminaire is below a predetermined threshold. Note that the label “LC<T?” may be taken to refer to the English language expression “lighting conditions less than threshold” as a convenient shorthand.

If the condition indicating that lighting conditions in the environment are below a predetermined threshold is not detected, or, equivalently, if it is detected that lighting conditions are at or above the threshold, which is sometimes called “dawn” in industry shorthand, then in some embodiments no specific further action needs to be taken and the method embodiment may halt (not illustrated, but this would simply be connecting the negative “N” option from the decision “LC<T?” to the “STOP” node. Alternatively, in some other embodiments, an explicit step, labelled “ACP”, may be taken of adapting a charging profile of the battery of the luminaire in order to increase power being extracted from the grid charging unit. Note that the label “ACP” may be taken to refer to the English language expression “adapting charging profile” as a convenient shorthand.

If the condition indicating that lighting conditions in the environment are below a predetermined threshold is detected, or, equivalently, if it is detected that lighting conditions are below the threshold, which is sometimes called “dusk” in industry shorthand, then operation of the method embodiment may proceed.

It is noted that in some further developed embodiments, the threshold and the condition may be inverted, such that the cut-off for the decision becomes the question whether or not the lighting conditions are above instead of below the predetermined threshold. Therefore, it would be equivalent to restate the mathematical comparison made in the second step as “LC>T?” or “LC<=T?” or “LC>=T?”, depending on the chosen threshold and/or depending on the meaning of “above” and “below” (i.e. “greater than” and “less than”).

It is explicitly noted that the order of the first and the second step may alternatively be switched, that is, in some embodiments, the second step may come before the first step, whereas in some other embodiments, the first step may come before the second step. In some further developed embodiments, the first step and the second step may alternatively be concurrent, that is, they may take place at the same time.

In a third step, labelled “LF?”, load flickering of the luminaire is detected. The load flickering may be considered to be attributable to a load ripple through the battery, wherein the load ripple is due to the coupling of the battery with the grid charging unit, because an inherent ripple stemming from the grid may pass through the grid charging unit, into the battery and into the load, thus potentially leading to a perceivable ripple in the output of the load, which is termed “load flickering” in the context of a luminaire. Note that the label “LF?” may be taken to refer to the English language expression “load flickering?” as a convenient shorthand.

If load flickering is not detected, or, equivalently, if no load flickering is detected, then no specific further action needs to be taken and the method embodiment may halt. This is because if load flickering would be corrected, that is, if the ripple would be reduced when the battery is not charging, so when no grid charging unit is coupled with the battery, this could deteriorate the system (battery discharging mode+load) performance.

If, however, load flickering is detected, the method embodiment may proceed to a step of correcting the load flickering of the luminaire, labelled “CLF”. Note that the label “CLF” may be taken to refer to the English language expression “correcting load flickering” as a convenient shorthand.

Thus, in other words, the load flickering is only corrected, i.e. the ripple is only reduced, when the grid charging unit is present during reduced lighting conditions. It is an advantage that no hardware change may be required. It is a further advantage that the luminaire may be compatible with many readily available types of grid charging unit.

The skilled person will understand that various other embodiments may be derived from the above-described embodiment, in accordance with the embodiments described in the summary above and/or in accordance with the claims. Moreover, the skilled person will understand that any or all of the above-described logic decisions and operations may be performed by a suitable element of the luminaire, e.g. a controller such as the controller described above.

Furthermore, in some further developed embodiments, any of the following preferred features may be implemented.

An example of such a preferred feature is that the condition indicating lighting conditions being below the predetermined threshold may be detected by detecting a lack of photovoltaic current reaching the battery from the solar unit.

Another example of such a preferred feature is that the condition indicating lighting conditions being below the predetermined threshold is detected by consulting a predefined timetable and using a datetime clock. This allows to make decisions in a more predictable manner.

Another example of such a preferred feature is that the step of determining whether or not the battery is being charged is performed by measuring a state of charge of the battery to determine whether or not the battery voltage is increasing.

Another example of such a preferred feature is that the step of detecting load flickering of the luminaire comprises detecting a load current ripple deviating from a load current setting by more than 3.5 percent, preferably by more than 5 percent. This allows to start making corrections only when it is worthwhile, i.e. only when the load flickering can be perceived by users.

In a practical implementation, the correction of the load flickering may be performed by a PWM controller through PID (proportional-integral-derivative) control. The controller may be configured to determine PID components and generate new factors per the grid frequency, with which it may be configured to control PWM of the light output driver (e.g. a LED driver) in such a way that the effect of ripple on the load becomes less than 3.5% or less than 5%. In this context, any suitable PID algorithm may be used, for which the parameters may be voltage V and current I for the load and for the battery.

Purely as an example for such a practical implementation, the skilled person may consider the following parameter settings to implement the PID control algorithm:

```
  Measure Current and Voltage parameters for both battery and light/LED load.
  Battery voltage and current are used to measure Battery AH, state of charge.
  Pled = Iled*Vled.
  Perror = SetPower − Pled
  Kp = Kfactor/ SetPower
  Ki=0 (or something else, as this can be tuned according to requirements)
  Kfactor = 20 (if no load flickering is detected and to provide for a faster
control loop; this value of Kfactor may however also be something other than 20)
  Kfactor = 5 (if load flickering is detected above a threshold of 5%, which may
mean a slower control loop tuned according to amount of load flickering observed; this value
of Kfactor may however also be something other than 5)
  Pout = Pout + Perror*(Kp + Ki) ;
  Set MOSFETs PWM = Pout*PwmCoff.
  PwmCoff = 1.0
```

The skilled person will understand that the above example parameter settings are provided merely as an example to show how to correct load flickering, and are not intended to limit embodiments of the present disclosure unduly.

Another example of such a preferred feature is that the predetermined threshold represents a cut-off between day time with higher lighting conditions and night time with lower lighting conditions.

Another example of such a preferred feature is that the predetermined threshold varies depending on the date and/or the season.

Another example of such a preferred feature is that the load current may be measured for at least 100 cycles, to better guarantee that it is worthwhile to commence correction of the load flickering.

In a first exemplary embodiment, a suitable element of the luminaire, e.g. a controller or the solar unit of the luminaire, may be configured to detect a so-called “dusk” condition, i.e. a condition indicating lighting conditions in an environment of the luminaire are below a predetermined threshold. Also, a suitable element of the luminaire, e.g. the controller of the luminaire, may be configured to determine whether or not the battery is being charged. When the controller detects such a “dusk” condition and detects that the battery is still charging (e.g. by measuring the state of charge of the battery, wherein a change of the state of charge may indicate that the battery voltage is increasing), then this means that a grid charging unit (i.e. a charging unit connected to the electrical mains grid), so an external current source, is probably coupled to the battery, which is charging the battery. If, in this state, a suitable element of the luminaire, e.g. the controller of the luminaire, measures or detects load flickering, then the load flickering may be corrected. This may for example be implemented in an output load control algorithm, wherein load coefficients of the load may be adjusted. This may advantageously happen without any communication between the controller of the luminaire and any external charge controller.

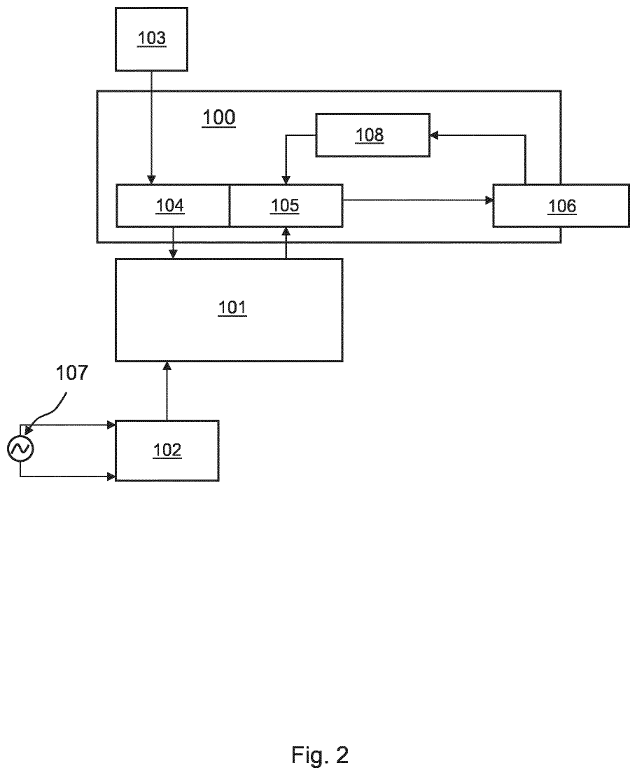

In the context of the present disclosure, the controller may be considered as a single integrated element, or may alternatively be considered as a combination of several distinct elements, such as a solar charge controller, a load driver, and various other electronic hardware components, as will be explained below with reference to FIG. 2.

In a second exemplary embodiment, a suitable element of the luminaire, e.g. a charge controller of the luminaire, may be configured to detect a so-called “dusk” condition, i.e. a condition indicating lighting conditions in an environment of the luminaire are below a predetermined threshold. Also, a suitable element of the luminaire, e.g. the controller of the luminaire, may be configured to determine whether or not the battery is being charged. When the controller detects such a “dusk” condition and detects that the battery charge is neither increasing nor decreasing, the controller may be configured to detect whether any external grid charging unit is connected or not, which could for example be an AC to DC SMPS (Alternating Current to Direct Current Switched Mode Power Supply). Once the controller detects the presence of such a grid charging unit (e.g. because the battery voltage is not decreasing), then the controller may be configured to implement load flickering detection and correction.

In a third exemplary embodiment, a suitable element of the luminaire, e.g. a controller of the luminaire, may be configured to detect a so-called “dawn” condition, i.e. a condition indicating lighting conditions in an environment of the luminaire are above a predetermined threshold. Also, a suitable element of the luminaire, e.g. the controller of the luminaire, may be configured to determine whether or not the battery is being charged with more power than the solar unit is providing. When the controller detects such a “dawn” condition and detects that the battery is being charged, so detects the presence of a grid charging unit, then the controller may adapt the charging profile of the battery in such a way that it extracts maximum power from the grid through the grid charging unit and/or from the solar unit and becomes fully charged during the “dawn” condition, i.e. during day time, only. A benefit of battery charging from the grid during day time is that once the battery is charged during the day, it can provide the luminaire's lighting load the whole following night without the need for an external grid charging unit. This approach may even help to avoid the risk of load flickering entirely, because it decouples the luminaire's light output from the grid.

In a fourth exemplary embodiment, a suitable element of the luminaire, e.g. a charge controller of the luminaire, may be configured to detect a so-called “dusk” condition, i.e. a condition indicating lighting conditions in an environment of the luminaire are below a predetermined threshold. Also, a suitable element of the luminaire, e.g. the controller of the luminaire, may be configured to determine whether or not the battery is being charged. When the controller detects such a “dusk” condition and detects that the battery is being charged, e.g. because of a grid charging unit, such as an external DC source, then the controller may detect the presence of load flickering. If there is no load flickering, then no correction may have to be implemented.

In a further developed embodiment, the luminaire may be configured to disable any new components because these new components may have been dimensioned according to grid conditions and may not be required during normal DC load driving, as otherwise these new components may lead to the risk of decreasing the performance of a light output driver of the light unit when working on DC.

FIG. 2 schematically illustrates an embodiment of a luminaire 100 according to the present disclosure. The luminaire 100 may comprise or be coupled to a battery 101. There may be a grid charging unit 102 coupled to the battery 101. The grid charging unit 102 may be fed from the mains grid 107. The luminaire 100 may comprise or be coupled to a solar unit comprising at least one solar panel 103 and a solar charge controller 104, which may form part of an overall controller of the luminaire 100. The solar charge controller 104 may be coupled to the at least one solar panel 103 and the battery 101. The luminaire 100 may also comprise a load driver 105 configured to drive a load 106, e.g. a LED or an array of LEDs, although any other suitable lighting technology may be used. The luminaire 100 may comprise a controller 108 configured to discern a load current from the load 106 and configured to feedback a control signal into the load driver 105, in order to effect changes to the load output setting.

The controller 108 may in some embodiments be implemented as a custom electronic hardware device, or may in other embodiments be implemented as one or more off-the-shelf electronic units. The controller 104 and the controller 108 may be considered as a single integrated element, or may alternatively be considered as a combination of several distinct elements, and may in some embodiments even include other elements of the luminaire, such as the load driver 105, if this is convenient.

1. A method of operating a luminaire, the luminaire comprising or connectable to a battery, the battery being coupled via a grid charging unit to a mains grid, and the luminaire comprising or being coupled to a solar unit, the method comprising:
detecting whether or not a condition indicating lighting conditions in an environment of the luminaire is below a predetermined threshold;
determining whether or not the battery is being charged;
if the condition indicating lighting conditions being below the predetermined threshold is detected and if it is determined that the battery is being charged, detecting load flickering of the luminaire, wherein the load flickering is attributable to a load ripple through the battery, wherein the load ripple is due to the coupling of the battery with the grid charging unit; and
if load flickering of the luminaire is detected, correcting the load flickering of the luminaire using a pulse-width modulation (PWM) controller.

2. The method of claim 1, comprising, if load flickering of the luminaire is not detected, or if it is determined that the battery is not being charged, maintaining an output state of the luminaire.

3. The method of claim 1, further comprising:
if the condition indicating lighting conditions being below the predetermined threshold is not detected and if it is determined that the battery is being charged, adapting a charging profile of the battery of the luminaire in order to increase power being extracted from the grid charging unit.

4. The method of claim 1, wherein the condition indicating lighting conditions being below the predetermined threshold is detected by detecting a lack of photovoltaic current reaching the battery from the solar unit.

5. The method of claim 1, wherein the condition indicating lighting conditions being below the predetermined threshold is detected by consulting a predefined timetable and using a datetime clock.

6. The method of claim 1, wherein the step of determining whether or not the battery is being charged is performed by measuring a state of charge of the battery to determine whether or not the battery voltage is increasing.

7. The method of claim 1, wherein the step of detecting load flickering of the luminaire comprises detecting a load current ripple deviating from a load current setting by more than 3.5 percent, preferably by more than 5 percent.

8. The method of claim 1, wherein the predetermined threshold represents a cut-off between day time with higher lighting conditions and night time with lower lighting conditions.

9. The method of claim 1, wherein the predetermined threshold varies depending on the date and/or the season.

10. (canceled)

11. A computer-readable storage medium comprising instructions which, when executed by a computer, cause the computer to carry out the method of claim 1.

12. (canceled)

13. A luminaire comprising or being connectable to a battery, the battery being coupled via a grid charging unit to a mains grid, and the luminaire comprising or being coupled to a solar unit; wherein the luminaire comprises a controller configured to cause the luminaire to:
detect whether or not a condition indicating lighting conditions in an environment of the luminaire is below a predetermined threshold;
determine whether or not the battery is being charged;
if the condition indicating lighting conditions being below the predetermined threshold is detected and if it is determined that the battery is being charged, detect load flickering of the luminaire, wherein the load flickering is attributable to a load ripple through the battery, wherein the load ripple is due to the coupling of the battery with the grid changing unit; and
if load flickering of the luminaire is detected, correct the load flickering of the luminaire using a pulse-width modulation (PWM) controller.
